(19) United States
(12) Patent Application Publication
(10) Pub. No.: US 2006/0074761 A1
(43) Pub. Date: Apr. 6, 2006

(54) Tracking after point of sale (APOS) related sales for peripherals

(76) Inventors: Shree A. Dandekar, Round Rock, TX (US); James A. Howell, JR., Georgetown, TX (US)

Correspondence Address: HAMILTON & TERRILE, LLP, P.O. BOX 203518, AUSTIN, TX, 78720, US

(21) Appl. No.: 10/947,023

(22) Filed: Sep. 21, 2004

(51) Int. Cl. G06Q 30/00

(52) U.S. Cl. 705/26

(57) ABSTRACT

A system for tracking after point of sale related sales for peripherals which includes an access module for accessing a customer computer system which includes a supplier specific unique identifier, a decision module, and an offer module. The decision module determines whether the customer computer system includes a supplier specific unique identifier. The offer module presents a factory installed offer if the customer computer system includes a supplier specific unique identifier and presents a non supplier offer if the customer computer system does not include a supplier specific unique identifier.

### BACKGROUND OF THE INVENTION

1. Field of the Invention

The present invention relates to the field of information handling system peripherals, and more particularly to tracking related sales for peripherals.

2. Description of the Related Services

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

One aspect of information handling system relates to the marketing and supply of information handling systems such as computer systems along with peripherals. Known information handling system suppliers such as Dell, Inc. provide peripherals via the same channel as their computer systems. However, the information handling system peripheral market continues to grow in complexity. It is known for information handling system suppliers to bundle existing software (e.g., music, photography, security, etc.) solutions with peripherals.

One aspect of ordering information handling systems relates to up-selling. Up selling relates to selling additional products or services relating to a particular product or service. For example, when a customer orders a music player such as an MP3 player, from a supplier, an up sell might be providing the user with a particular number of music downloads for use with the music player. It is known to allow a customer when ordering an information handling system to order peripherals and up sells at the point of sale (POS) of the computer system and peripheral.

Alternately, a customer may solely purchase a peripheral without purchasing a computer system. Additionally, some customers may not wish to purchase any additional products or services when purchasing a new information handling system.

However, there is not a standard process defined for tracking subscription product up sells sold with a peripheral on non supplier information handling systems. For example, a supplier might bundle a service, such as the MusicMatch service, with certain music players. It is desirable to differentiate between service subscriptions that occur on a non supplier computer system using supplier provided peripherals and subscriptions that occur on a supplier computer system which includes factory installed software. It is also desirable to perform this differentiation without creating multiple code bases for the same application.

### SUMMARY OF THE INVENTION

In accordance with the present invention, a customer may purchase a supplier peripheral (on-line or via a sales person) and select any number of third party services or software applications. The applications or services may be sold with different offers when purchased with a peripheral versus when purchased with a supplier computer system versus when purchased independent of a supplier computer system. The customer then receives the peripheral. When registering for the services selected during purchase, the service or software provider access the customer's computer system. If a supplier unique identifier is not retrieved, then the registration process identifies the registration as occurring on a non supplier computer system. The registration process may also ensure the validity of the supplier peripheral via checks on the peripheral firmware to ensure that the peripheral is actually a supplier peripheral. The registration process may also include offers for additional up sells. For example, the offer shown may be presented based on whether or not the subscription was occurring on a supplier computer system or a non supplier computer system.

The present invention relates to the overall model or process of determining whether a computer system that the software or service is being installed on is a supplier computer system and storing that information at the supplier. This information allows a supplier to tailor offers based on whether the subscription occurs on a supplier computer system or on a computer system from a different manufacturer. The information also enables a supplier to track where service registrations are occurring.

In one embodiment, the invention relates to a system for tracking after point of sale related sales for peripherals which includes an access module for accessing a customer computer system which includes a supplier specific unique identifier, a decision module, and an offer module. The decision module determines whether the customer computer system includes a supplier specific unique identifier. The offer module presents a factory installed offer if the customer computer system includes a supplier specific unique identifier and presents a non supplier offer if the customer computer system does not include a supplier specific unique identifier.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 shows a block diagram of a customer accessing a system configuration store.

FIG. 2 shows a system block diagram of an information handling system.

FIG. 3 shows a schematic block diagram of the system configuration store.

FIG. 4 shows a flow chart of a process for tracking after point of sale up sells.

FIG. 5 shows a flow chart of a process for tracking after point of sale up sells for a music player peripheral.

FIG. 6 shows a flow diagram of the configuration of an information handling system to include the customization features.

### DETAILED DESCRIPTION

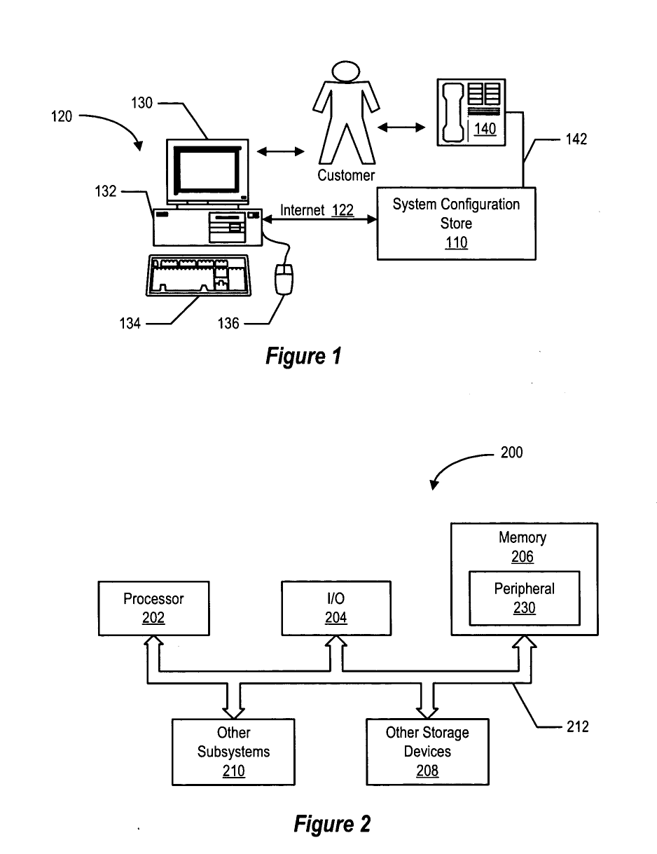

Referring to FIG. 1, a customer can access a system configuration store 110 using any suitable computer equipment 120, via the Internet 122. The computer equipment 120 may include a display 130, computer 132, keyboard 134, and pointing device 136. Display 130 is used for displaying the various pages of the on-line store while a customer is using the on-line store. Alternately, a customer can access the system configuration store 110 via a telephone 140 which is coupled to the system configuration store via a telephone network 142. In the case of a telephone access to the system configuration store, the customer speaks with a sales representative who obtains the configuration information from the customer and in turn enters the information into the system configuration store 110 to configure a system. The system configuration store 110 also enables a customer to purchase peripherals either with a system or independent of a system.

Referring to FIG. 2, a system block diagram of an information handling system 200 is shown having features configured in accordance with the system configuration store 110. The information handling system 200 includes a processor 202, input/output (I/O) devices 204, such as a display, a keyboard, a mouse, and associated controllers, memory 206 including volatile memory such as random access memory (RAM) and non-volatile memory such as a hard disk and drive, and other storage devices 208, such as a floppy disk drive, a CD ROM drive and other memory devices, and various other subsystems 210, all interconnected via one or more buses 212.

The information handling system may include peripheral related software 230 stored within the memory 206.

For purposes of this invention, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

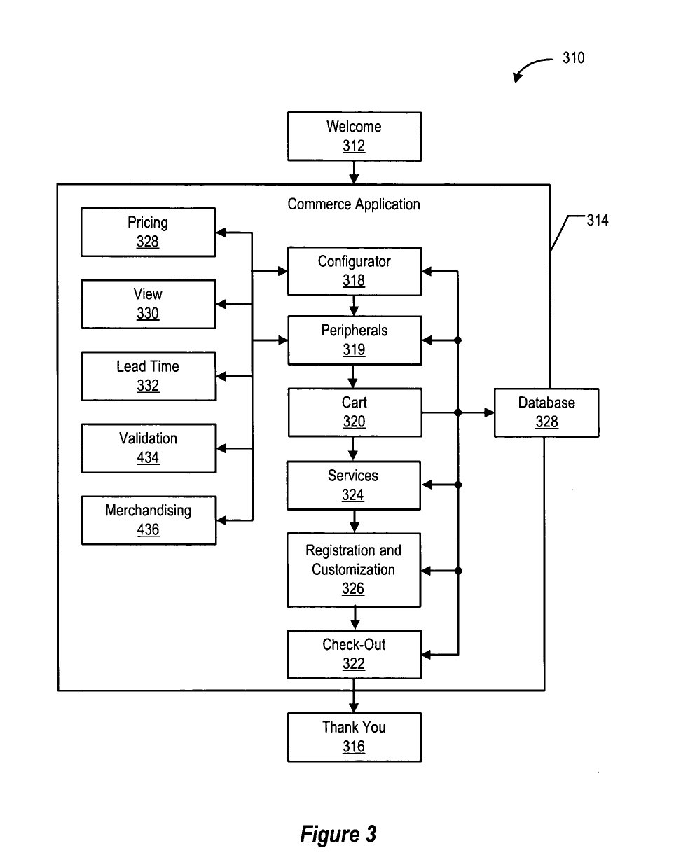

Referring to FIG. 3, an on-line store is a component of an Internet website to which a customer may go to configure a particular information handling system, for example, according to desired options of the customer. An on-line store is one example of a system configuration store 110. The on-line store is typically a subset of a larger Internet website. At the on-line store, a customer can select one or more products in which the customer is interested. Upon selection of a particular product, the on-line store presents the customer with the ability to go to the product information for the particular product, customize the product, price the customized product, purchase the product, and other actions as discussed herein. While shopping happens in the website (i.e., selection of a particular kind of system by a customer), when the customer is ready to purchase a customized system, the customer is then directed to that part of the website which the on-line store application controls.

An on-line store 310 for use in generating customer configured information handling systems, e.g., customer configured computer systems, is shown. The on-line store 310 includes a welcome or introductory module 312, a commerce application module 314, and a thank you module 316. The on-line store 310 includes an on-line store user interface which enables the system configuration, pricing, and ordering of an information handling system via the Internet. The commerce application 314 includes a configurator 318, a peripheral module 319, a shopping cart 320, a checkout module 322, a services activation module 324, a registration and customization module 326 and database 328. The database 328 provides information to the configurator 318, peripherals module 319, shopping cart 320, checkout module 322, services activation module 324 and registration and customization module 326. The configurator 318 (and the peripherals module 319) includes a pricing module 328, a view module 330, a lead time warning module 332, a validation (or compatibility) warning module 334, and a merchandising module 336. The various modules of the configurator 318 are driven by data from the database 328, and thus the configurator 318, shopping cart 320, checkout module 322 and services activation module 324 are all linked to the database 328.

In operation of the on-line store 310, the welcome module 312 presents a welcome page 312, the configurator 318 presents a configurator page, the peripherals module 319 presents a peripherals page, the shopping cart 320 presents a shopping cart page, the checkout module 322 presents a checkout page, the services activation module 324 presents a services activation page, the registration and customization module 326 provides a registration and customization page and the thank you module 316 presents a thank you page. The welcome page includes a static page and generally resides outside of the commerce application 314. The configurator page, peripherals page, shopping cart page, checkout page, services activation page and registration and customization page are within the commerce application and use information provided by the database. The checkout includes a payment feature, delivery feature, personal versus business feature, and instructional text features (i.e., how to fill out an on-line form.)

The welcome page is typically an introductory page and includes a link into the on-line store 310. The welcome page is typically a static welcome page. Upon completion of configuration of a system, is transferred to a services activation page in which the customer is provided an opportunity to activate various services such as internet service or content services such as music services. After completion of the services activation, the customer is transferred to the registration and customization page. After completion of the registration and customization, the customer is transferred to a checkout page. After completion of the checkout, the customer is transferred to a static thank you page. The thank you page provides a message of gratitude to the customer for having placed the order or for visiting the on-line store.

Aspects of the configurator 318 which interact with database 328 are shown in FIG. 3. In essence, the entire commerce application 314 interacts with the database. The configurator 318, peripherals module 319, shopping cart 320, checkout module 322, services activation module 324 and registration and customization module are each part of the commerce application 314 and interact with the database 328. For example, with the shopping cart 320, additional merchandising information associated with a particular system which has been configured and placed in the shopping cart by an on-line store customer can be provided.

Also for example, various services may be provided for order by the customer by the services module 324 based upon the type of system or peripherals ordered as well as components that are included within the system ordered. Additionally, by providing the services module within the commerce application 314, the customer continues the experience a similar customer experience and the system provider is able to use the information from the database 328 and to maintain control over the customer contact. By maintaining control over the customer contact the system provider is able to determine what services are activated and to maintain accurate and up to date records of the service activation. The services module 324 includes a proactive point of sale prequalification module.

When a purchase is processed via the telephone, then the customer representative interacts with a system similar to configurator 318.

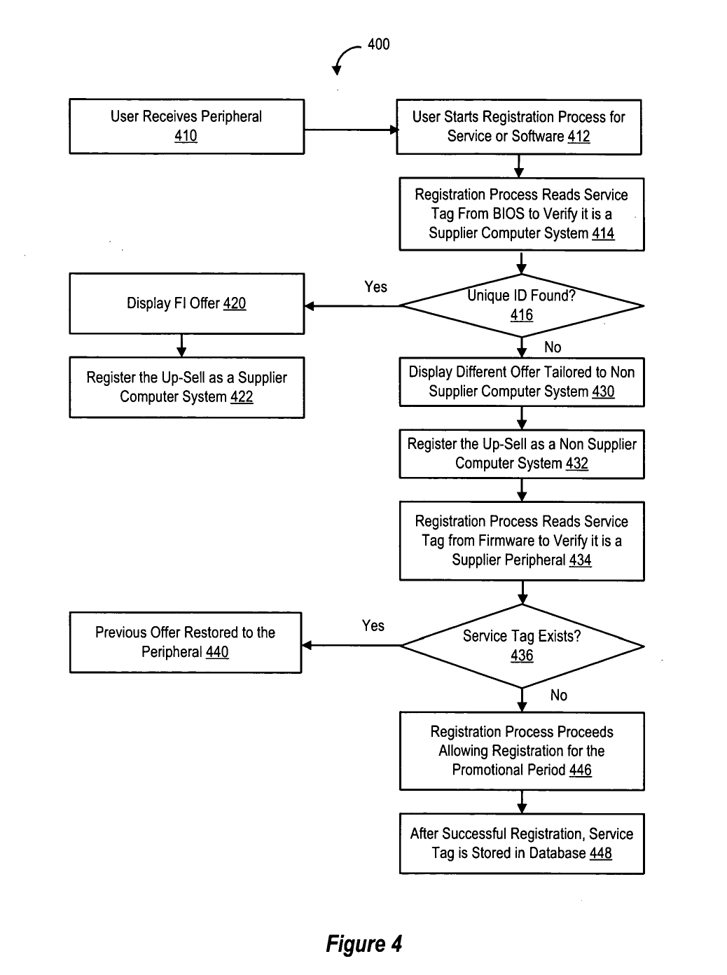

Referring to FIG. 4, a flow chart of a process for tracking after point of sale up sells is shown. More specifically, a user receives a peripheral after completing the supplier's order process at step 410. The user then initiates a registration process for a service or software product relating to the peripheral at step 412. During the registration process, the peripheral supplier accesses the user computer system (this access may be after obtaining the user's approval) to verify wither the user computer system is a supplier computer system at step 414. This access may access a supplier service tag or some other form of supplier specific information that is stored within the user computer system. A service tag is an example of an identifier that is both supplier specific and system specific, i.e., the service tag uniquely identifies the system as a particular system to the system supplier.

If a unique identifier is located at step 416, then the process proceeds to present a factory installed offer at step 420 and registers the up sale as corresponding to a supplier computer system at step 422. If a unique identifier is not found at step 416, then the peripheral supplier presents an offer that is tailored to a non supplier computer system at step 430. The process continues by registering the up sale as corresponding to a non supplier computer system at step 432.

The registration process continues by accessing firmware within the peripheral to access a service tag of the peripheral to verify that the peripheral is supplied by the peripheral supplier at step 434. If a service tag is present as determined by step 436, then the previous offer is restored to the peripheral at step 440.

If the service tag is not present as determined by step 436, then the registration process proceeds allowing registration for a promotional period at step 446.

After the peripheral is successfully registered, then the service tag of the peripheral is stored in a database along with information regarding any related up sales at step 448.

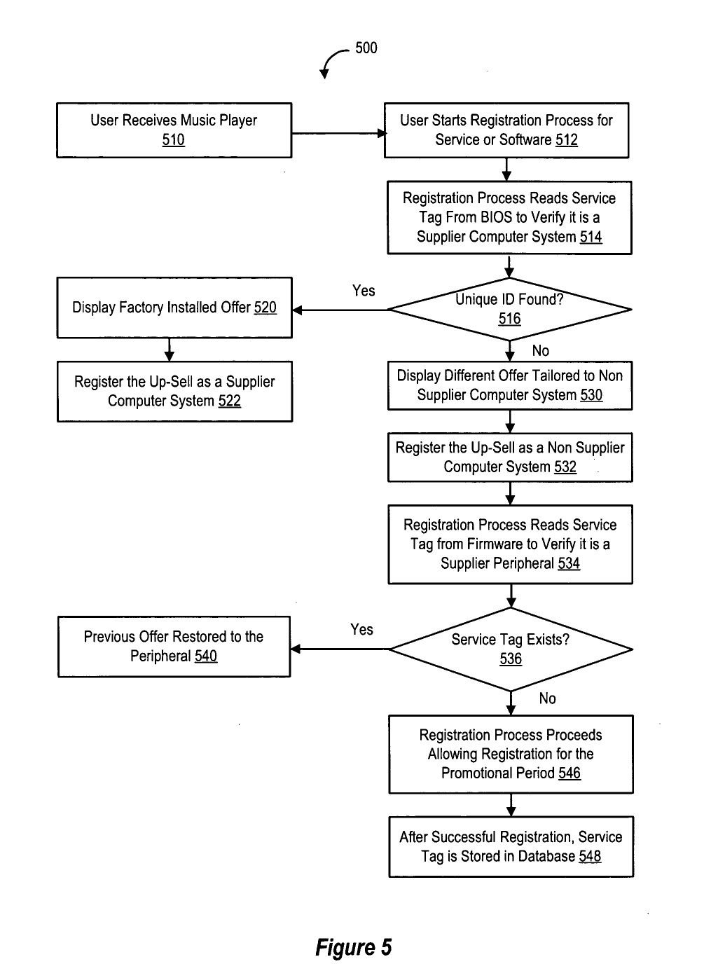

Referring to FIG. 5, a flow chart of a process for tracking after point of sale up sells for a music player peripheral is shown. More specifically, a user receives the music player after completing the supplier's order process at step 510. The user then initiates a registration process for a service or software product relating to the music player such as a music service at step 512. During the registration process, the peripheral supplier accesses the user computer system (this access may be after obtaining the user's approval) to verify wither the user computer system is a supplier computer system at step 514. This access may access a supplier service tag or some other form of supplier specific information that is stored within the user computer system. A service tag is an example of an identifier that is both supplier specific and system specific, i.e., the service tag uniquely identifies the system as a particular system to the system supplier.

If a unique identifier is located at step 516, then the process proceeds to present a factory installed offer for, e.g., music services, at step 520 and registers the up sale as corresponding to a supplier computer system at step 522. If a unique identifier is not found at step 516, then the peripheral supplier presents an offer that is tailored to a non supplier computer system at step 530. The process continues by registering the up sale as corresponding to a non supplier computer system at step 532.

The registration process continues by accessing firmware within the music player to access a service tag of the music player to verify that the music player is supplied by the peripheral supplier at step 534. If a service tag is present as determined by step 536, then the previous offer is restored to the peripheral at step 540.

If the service tag is not present as determined by step 536, then the registration process proceeds allowing registration for a promotional period at step 546.

After the music player is successfully registered, then the service tag of the peripheral is stored in a database along with information regarding any related up sales at step 548.

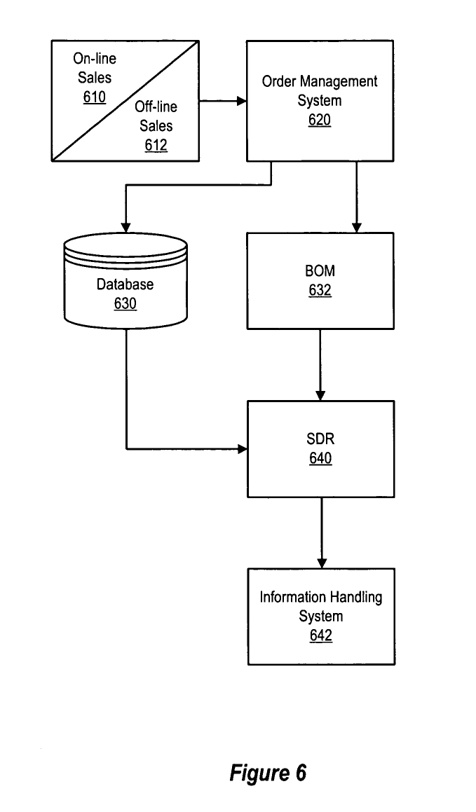

Referring to FIG. 6, when registration or customization information is obtained either via on-line sales 610 or via off-line (e.g., telephone) sales 612, the information is provided to an order management system 620 which interacts with the factory in which the system is manufactured. The order management system 620 stores this information to a database 630 as well as to a Bill of Materials (BOM) 632 which is associated with a particular system being manufactured or peripheral being purchased. It will be appreciated that one or both the database 630 or the BOM 632 may be used to transfer the information from the customer order to a particular information handling system. The information is then stored in a system descriptor record (SDR) which is stored on the memory of the information handling system 642 being manufactured. Certain types of peripherals (e.g., printers) may also be information handling systems on which this information may be stored. Accordingly, the registration or customization information that is obtained from the customer is stored on the system that is manufactured for that customer.

### Other Embodiments

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

For example, it will be appreciated that the order in which the customer is presented with the services activation page, the registration and customization page and check out page may vary. E.g., the customer may checkout before accessing the services activation page. Alternately, the services activation module may not be presented at all.

Also for example, other types of peripherals (e.g., cameras, personal digital assistants (PDAs), printers, etc.) are contemplated. These other types of peripherals may also include corresponding offers. For example, a camera might include an offer for photo services, a PDA might include an offer for a case or a car kit, a printer might include an offer for an ink subscription.

Also for example, the above-discussed embodiments include software modules that perform certain tasks. The software modules discussed herein may include script, batch, or other executable files. The software modules may be stored on a machine-readable or computer-readable storage medium such as a disk drive. Storage devices used for storing software modules in accordance with an embodiment of the invention may be magnetic floppy disks, hard disks, or optical discs such as CD-ROMs or CD-Rs, for example. A storage device used for storing firmware or hardware modules in accordance with an embodiment of the invention may also include a semiconductor-based memory, which may be permanently, removably or remotely coupled to a microprocessor/memory system. Thus, the modules may be stored within a computer system memory to configure the computer system to perform the functions of the module. Other new and various types of computer-readable storage media may be used to store the modules discussed herein. Additionally, those skilled in the art will recognize that the separation of functionality into modules is for illustrative purposes. Alternative embodiments may merge the functionality of multiple modules into a single module or may impose an alternate decomposition of functionality of modules. For example, a software module for calling sub-modules may be decomposed so that each sub-module performs its function and passes control directly to another sub-module.

Consequently, the invention is intended to be limited only by the spirit and scope of the appended claims, giving full cognizance to equivalents in all respects.

What is claimed is:

1. A system for tracking after point of sale related sales for peripherals comprising:
an access module for accessing a customer computer system includes a supplier specific unique identifier;
a decision module, the decision module determining whether the customer computer system includes a supplier specific unique identifier; and,
an offer module, the offer module presenting a factory installed offer if the customer computer system includes a supplier specific unique identifier and presenting a non supplier offer if the customer computer system does not include a supplier specific unique identifier.

2. The system of claim 1 further comprising:
a sale type determination module, the type of sale determination module determining whether the peripheral was purchased with a supplier computer system or the peripheral was purchased independent of a supplier computer system.

3. The system of claim 2 wherein:
the offer module presents the factory installed offer if the peripheral was purchased with a supplier computer system; and,
the offer module presents a supplier specific offer if the peripheral was purchased independent of a supplier computer system and the customer computer system includes a supplier specific code.

5. The system of claim 1 wherein
the peripheral is at least one of a music player, a camera, a personal digital assistant and a printer.

6. The system of claim 1 wherein
the peripheral includes a supplier unique identifier.
